(19) United States
(12) Patent Application Publication
(10) Pub. No.: US 2026/0149629 A1
(43) Pub. Date: May 28, 2026

(54) COMMUNICATION METHOD AND COMMUNICATION SYSTEM

(71) Applicant: Ningbo University, NINGBO (CN)

(72) Inventors: Gang WANG, NINGBO (CN); Danyan LIN, NINGBO (CN); King Choi HO, Columbia, MO (US)

(21) Appl. No.: 19/215,384

(22) Filed: May 22, 2025

(30) Foreign Application Priority Data
Nov. 28, 2024 (CN) 202411726198.1

(51) Int. Cl. H04L 27/00; H04L 27/26

(52) U.S. Cl. CPC H04L 27/0014; H04L 27/2628; H04L 27/265

(57) ABSTRACT

The present application provides a communication method and a communication system. The communication method, applied to a transmitter, includes: collecting a bitstream; modulating and converting the bitstream and obtaining a frequency domain signal matrix; multiplying the frequency domain signal matrix with an inverse approximate Discrete Fourier Transform (DFT) matrix and obtaining a time domain signal matrix; post-processing the time domain signal matrix and obtaining a time domain signal, and sending the time domain signal to a receiver connected with the transmitter. The communication method, applied to a receiver, includes: receiving a time domain signal from a transmitter connected with the receiver; pre-processing the time domain signal and obtaining a time domain signal matrix; multiplying the time domain signal matrix with an approximate DFT matrix and obtaining a frequency domain signal matrix; demodulating and converting the frequency domain signal matrix and obtaining a bitstream.

### CROSS-REFERENCE TO RELATED APPLICATIONS

The present application claims priority to Chinese Patent Application No. 202411726198.1, entitled “FAST DFT APPROXIMATION METHOD BASED ON SPARSE FACTOR OPTIMIZATION”, filed on Nov. 28, 2024, which is herein incorporated by reference in its entirety.

### TECHNICAL FIELD

The present disclosure relates to the technical field of communications, in particular, to a communication method and a communication system.

### BACKGROUND

OFDM is a modulation technology widely applied in high-speed communication systems, which may divide the available bandwidth into multiple subcarriers to achieve efficient data transmission. DFT plays a key role in OFDM systems. DFT may convert data into the frequency domain, enabling information to be modulated onto orthogonal subcarriers. This conversion ensures the orthogonality of the subcarriers, reduces interference, and improves spectral efficiency.

Discrete Fourier Transform (DFT) is a fundamental tool widely utilized in various fields such as engineering, science, and mathematics.

In the field of numerical analysis, the Fast Fourier transform (FFT) is a widely used algorithm that converts a time-domain signal into a frequency-domain signal or vice versa.

The fast computational ability of FFT has enabled its extensive application in the fields of digital signal processing, image processing, audio processing, etc. However, as the volume of data increases, the computational complexity of FFT also increases. Therefore, how to improve the computational efficiency of FFT becomes an important research topic. In the field of fast algorithms, sparse matrix is an important tool, which refers to a matrix with relatively few non-zero elements. Due to the properties of sparse matrices, many computational problems can be accelerated to be solved by sparse matrices. For example, in the field of numerical computation methods, sparse matrices are widely used in solving linear equations, optimization problems, and machine learning algorithms.

### SUMMARY

A first aspect of the present disclosure provides a communication method. The communication method applies to a transmitter, including: collecting a bitstream; modulating and converting the bitstream and obtaining a frequency domain signal matrix; multiplying the frequency domain signal matrix with an inverse approximate Discrete Fourier Transform (DFT) matrix and obtaining a time domain signal matrix, the inverse approximate Discrete Fourier Transform (DFT) matrix being an inverse matrix of an approximate Discrete Fourier Transform (DFT); post-processing the time domain signal matrix and obtaining a time domain signal, and sending the time domain signal to a receiver connected with the transmitter.

A second aspect of the present disclosure provides a communication method. The communication method applies to a receiver, including receiving a time domain signal from a transmitter connected with the receiver; pre-processing the time domain signal and obtaining a time domain signal matrix; multiplying the time domain signal matrix with an approximate DFT matrix and obtaining a frequency domain signal matrix; demodulating and converting the frequency domain signal matrix and obtaining a bitstream.

A third aspect of the present disclosure provides a communication system. The communication system includes a transmitter and a receiver, the transmitter including a modulator, a first multiplier, and a post-processing circuit, the modulator being connected to an input end of the transmitter, the first multiplier being connected to an output end of the modulator, and the post-processing circuit being connected to an output end of the first multiplier, where the modulator is configured to modulate and convert the bitstream and obtain a frequency domain signal matrix, the first multiplier is configured to multiply the frequency domain signal matrix with an inverse approximate Discrete Fourier Transform (DFT) matrix and obtain a time domain signal matrix, the inverse approximate Discrete Fourier Transform (DFT) matrix being an inverse matrix of an approximate Discrete Fourier Transform (DFT), the post-processing circuit is configured to post-process the time domain signal matrix and obtain a time domain signal, and send the first domain signal to the receiver connected with the transmitter, the receiver includes a pre-processing circuit, a second multiplier, and a demodulator; the pre-processing circuit is connected to an input end of the receiver; the second multiplier is connected to an output end of the pre-processing circuit; the demodulator is connected to an output end of the second multiplier, the pre-processing circuit is configured to pre-process a time domain signal received from a transmitter connected with the receiver and obtain a time domain signal matrix; the second multiplier is configured to multiply the time domain signal matrix with an approximate DFT matrix and obtain a frequency domain signal matrix; the demodulator is configured to demodulate and convert the frequency domain signal matrix and obtain a bitstream.

### BRIEF DESCRIPTION OF THE DRAWINGS

FIG. 1 is a schematic flowchart illustrating a method of the present disclosure.

FIG. 2 is a signal flow diagram of an 8-point DFT approximation by using a feasible set P={0, ±1, ±2, . . . , ±2^{q}}.

FIG. 3 is a signal flow diagram of an 8-point DFT approximation by using a feasible set

$$N = \{ 0 , \pm \frac{1}{2} , \pm 1 \} .$$

FIG. 4 is a schematic structural view of a communication system in some embodiments of the present disclosure.

FIG. 5 is a schematic flowchart of a communication method in some embodiments of the present disclosure.

FIG. 6 is a schematic flowchart of a communication method in some embodiments of the present disclosure.

FIG. 7 is a schematic waveform graph of a communication system in some embodiments of the present disclosure.

FIG. 8 is a schematic waveform graph of a communication system in some embodiments of the present disclosure.

### DETAILED DESCRIPTION

The present disclosure is further described in detail below in conjunction with the embodiments illustrated in the accompanying drawings.

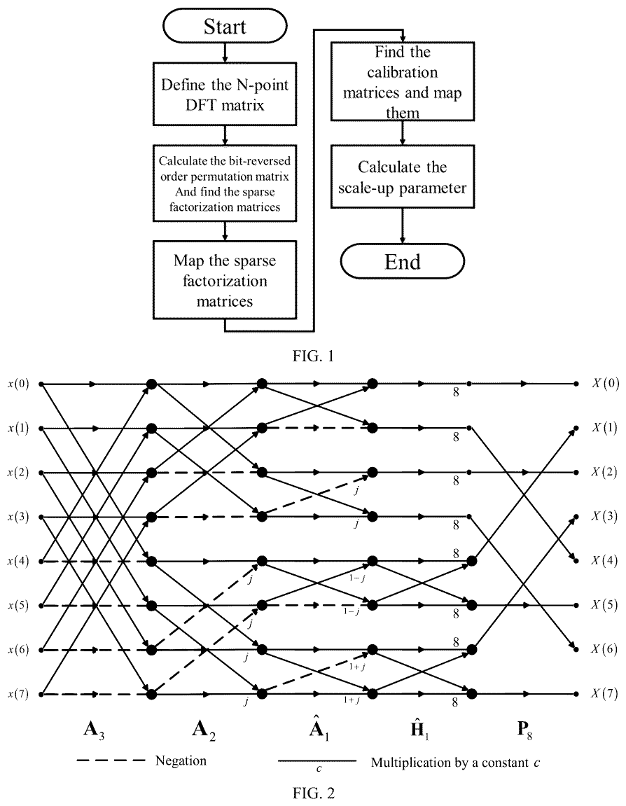

The present disclosure provides a fast DFT approximation method based on sparse factor optimization. The overall implementation block diagram of this method is illustrated in FIG. 1, which includes operations executed by the following blocks.

At block 1, a sparse factor matrix F_{N} of an N-point DFT matrix, where N is a power of two integer, based on a symmetric structure of the DFT matrix is constructed, where

$${F}_{N , ( k , i )} = {ω}_{N}^{( k - 1 ) ( i - 1 )} ,$$

k=1, 2, . . . , N, i=1, 2, . . . , N, where ω_{N}=e^{-j2π/N} is a Nth unit root, j=\sqrt{−1} is an imaginary unit,

$${ω}_{N}^{( k - 1 ) ( i - 1 )}$$

represents a (k−1)(i−1)th power of ω_{N}, and F_{N,(k,i)} represents a (k,i)th element of the matrix F_{N}.

At block 2: the sparse factor matrix F_{N} of the N-point DFT matrix F_{N} is factorized by a formula of

$${F}_{N} = {P}_{N} {\prod }_{i = 1}^{t} {A}_{i} ,$$

where t=log₂ N and P_{N} is a bit-reversal order permutation matrix.

In a case where the bit-reversal order permutation matrix P_{N}=[eᵣ_{_{N,(1)}}, eᵣ_{_{N,(2)}}, . . . eᵣ_{_{N,(N)}}] as a bit-reversed sequence is r_{N}, wherein eₗ is a l+1th column of a N×N unit matrix, r_{N,(l)} is a lth element of r_{N}, Aᵢ is expressed as

$${A}_{i} = blkdiag ( [ \begin{matrix}1 & {ω}_{N}^{{r}_{N , ( 1 )}} \\ 1 & {ω}_{N}^{{r}_{N , ( 2 )}}\end{matrix} ] , [ \begin{matrix}1 & {ω}_{N}^{{r}_{N , ( 3 )}} \\ 1 & {ω}_{N}^{{r}_{N , ( 4 )}}\end{matrix} ] , … , [ \begin{matrix}1 & {ω}_{N}^{{r}_{N , ( {2}^{( t - i + 1 )} - 1 )}} \\ 1 & {ω}_{N}^{{r}_{N , ( {2}^{( t - i + 1 )} )}}\end{matrix} ] ) ⊗ {I}_{{2}^{i - 1}} .$$

Taking N=8 as an example, when the natural order sequence is {0,1,2,3,4,5,6,7}, its binary representation is {000,001,010,011100,101,1011}. Then the bit-reversed binary representation is {000,100,010,110,001,101,011,111}. The bit-reversed sequence is thus obtained as {0,4,2,6,1,5,3,7}. Based on the bit-reversed sequence, the bit-reversal order permutation matrix in this case is P₈=[e₀,e₄,e₂,e₆,e₁,e₅,e₃,e₇]. Each Aᵢ is a full-rank N×N sparse matrix. By putting the bit-reversed order sequence into a N×1 vector, we obtain r_{N}. Aᵢ can be expressed as

$${A}_{i} = blkdiag ( [ \begin{matrix}1 & {ω}_{N}^{{r}_{N , ( 1 )}} \\ 1 & {ω}_{N}^{{r}_{N , ( 2 )}}\end{matrix} ] , [ \begin{matrix}1 & {ω}_{N}^{{r}_{N , ( 3 )}} \\ 1 & {ω}_{N}^{{r}_{N , ( 4 )}}\end{matrix} ] , … , [ \begin{matrix}1 & {ω}_{N}^{{r}_{N , ( {2}^{( t - i + 1 )} - 1 )}} \\ 1 & {ω}_{N}^{{r}_{N , ( {2}^{( t - i + 1 )} )}}\end{matrix} ] ) ⊗ {I}_{{2}^{i - 1}} ,$$

where blkdiag(·) denotes a block diagonal matrix including specified matrices on a diagonal of the block diagonal matrix, ⊗ is the Kronecker product operation, and r_{N,(l)} is a lth element of r_{N}.

At block 3, two feasible sets, P={0, ±1, ±2, . . . , ±2^{q}} and

$$N = \{ 0 , \pm \frac{1}{2} , \pm 1 \}$$

are defined, where q is a non-negative integer.

The factor matrix is mapped to the feasible set P={0, ±1, ±2, . . . , ±2^{q}}, where q is a non-negative integer, to obtain a first quantized-mapping factor matrix, i.e., Âᵢ=ƒ_{P=}(Aᵢ).

The factor matrix is mapped to the feasible set

$$N = \{ 0 , \pm \frac{1}{2} , \pm 1 \}$$

to obtain a second quantized-mapping factor matrix, i.e., Âᵢ=ƒ_{N=}(Aᵢ).

Except for Aₜ₋₁ and Aₜ, according to the above definition, all the elements in Aₜ₋₁ and Aₜ satisfy constraints of the feasible sets. Therefore, there is no need to perform a mapping operation. The real and imaginary parts of elements of rest matrices Aᵢ are not always in the feasible set and thus needs to perform the mapping operation, which are replaced with closest values from the feasible set. A mapping function ƒ_{P=}(·) of the feasible set P={0, ±1, ±2, . . . , ±2^{q}} and ƒ_{N=}(·) of the feasible set

$$N = \{ 0 , \pm \frac{1}{2} , \pm 1 \}$$

are defined such that an approximation result of Aᵢ is Âᵢ=ƒ_{P=}(Aᵢ) or Âᵢ=ƒ_{N=}(Aᵢ).

At block 5, the method performs amplitude calibration and phase calibration on the first quantized-mapping factor matrix or the second quantized-mapping factor matrix, including operations in the following.

The matrix Âᵢ after quantization mapping is calibrated in amplitude and phase by introducing a calibration matrix Hᵢ. Elements in the calibration matrix Hᵢ still need to satisfy constraints of the feasible set. As the constraints of the feasible set are discrete constraints, which are hard to be directly processed, these constraints may be temporarily abandoned first. Instead, a least squares problem

$${\overline{H}}_{i} = arg {min}_{{H}_{i}} {‖ {H}_{i} {Â}_{i} - {A}_{i} ‖}_{F}^{2}$$

may be constructed, enabling the matrix HᵢÂᵢ after calibration approximates the original matrix Aᵢ, where ∥·∥_{F} is the Frobenius norm. The optimal solution to a least squares problem can be obtained directly by H̅ᵢ=AᵢÂᵢ⁻¹. It should be noted that both Aᵢ and Âᵢ are sparse matrices, and the specific structure of the sparse matrix enables positions of non-zero elements in Âᵢ⁻¹ be the same as that in Aᵢ. Therefore, they still are sparse matrices that have no more than 2 non-zero elements in each column and each row.

H̅ᵢ may include an element that is not in the feasible set, which thus needs to be mapped. Since the non-zero elements of Aᵢ are always located on the unit circle and the non-zero elements of Âᵢ are always located on or outside the unit circle, making the elements of H̅ᵢ always located on or within the unit circle. When using the feasible set

$$N = \{ 0 , \pm \frac{1}{2} , \pm 1 \} ,$$

H̅ᵢ is mapped as Ĥᵢ=ƒ_{N=}(H̅ᵢ) When using the feasible set P={0, ±1, ±2, . . . , ±2^{q}}, if the non-zero elements in H̅ᵢ are mapped directly, the elements after mapping may be limited to −1, 0, or 1, resulting to too large error of approximation. To address this issue, a scaling parameter αᵢ is introduced before mapping H̅ᵢ, where αᵢ is decided by the minimum absolute value of the non-zero elements in H̅ᵢ. Let εᵢ be the minimum absolute value of the non-zero elements in H̅ᵢ, then αᵢ=^{┌-log}^{₂}^{ε}^{ᵢ}^{┐}. H̅ᵢ is mapped as H̅ᵢ=ƒ_{P=}(αᵢH̅ᵢ), ensuring the minimum value in H̅ᵢ is mapped to ±1, which may have an effective calibration on each element of Âᵢ.

At block 6, the method optimizes the sparse factor matrix F_{N} by a real scaling factor \hat{β} and outputs the approximate DFT matrix. A real scaling factor β is introduced to optimize the overall result. Let

$${G}_{N} = {\prod }_{i = 1}^{t - 2} {\hat{H}}_{i} {Â}_{i} {A}_{t - 1} {A}_{t} ,$$

then a least squares problem

$$\hat{β} = arg {min}_{β} {‖ {βP}_{N} {G}_{N} - {F}_{N} ‖}_{F}^{2}$$

is constructed. The optimal solution of the least squares problem may be expressed by a closed-form expression

$$\hat{β} = Re ( \frac{Tr ( {F}_{N}^{†} {P}_{N} {G}_{N} )}{Tr ( {G}_{N}^{†} {G}_{N} )} ) .$$

Finally, the approximate result of the N-point DFT matrix is

$${\hat{F}}_{N} = \hat{β} {\prod }_{i = 1}^{t - 2} {\hat{H}}_{i} {Â}_{i} {A}_{t - 1} {A}_{t} .$$

To validate the feasibility and effectiveness of the proposed method, simulation experiment is conducted.

Taking N=8 as an example, the bit-reversal order permutation matrix is P₈=[e₀,e₄,e₂,e₆,e₁,e₅,e₃,e₇]. The 8-point DFT matrix after the bit-reversed order permutation

$${P}_{8} {F}_{8} = [ \begin{matrix}1 & 1 & 1 & 1 & 1 & 1 & 1 & 1 \\ 1 & - 1 & 1 & - 1 & 1 & - 1 & 1 & - 1 \\ 1 & {ω}_{8}^{2} & - 1 & - {ω}_{8}^{2} & 1 & {ω}_{8}^{2} & - 1 & - {ω}_{8}^{2} \\ 1 & - {ω}_{8}^{2} & - 1 & {ω}_{8}^{2} & 1 & - {ω}_{8}^{2} & - 1 & {ω}_{8}^{2} \\ 1 & {ω}_{8} & {ω}_{8}^{2} & {ω}_{8}^{3} & - 1 & - {ω}_{8} & - {ω}_{8}^{2} & - {ω}_{8}^{3} \\ 1 & - {ω}_{8} & {ω}_{8}^{2} & - {ω}_{8}^{3} & - 1 & {ω}_{8} & - {ω}_{8}^{2} & {ω}_{8}^{3} \\ 1 & {ω}_{8}^{3} & - {ω}_{8}^{2} & {ω}_{8} & - 1 & - {ω}_{8}^{3} & {ω}_{8}^{2} & - {ω}_{8} \\ 1 & - {ω}_{8}^{3} & - {ω}_{8}^{2} & - {ω}_{8} & - 1 & {ω}_{8}^{3} & {ω}_{8}^{2} & {ω}_{8}\end{matrix} ] .$$

It can be observed that the submatrix in the upper left is identical to the 4×4 submatrix in the upper right, and the 4×4 submatrix in the lower left is opposite to that in lower right in sign. Hence, it may be factorized to

$${P}_{8} {F}_{8} = [ \begin{matrix}1 & 1 & 1 & 1 & & & & \\ 1 & - 1 & 1 & - 1 & & & & \\ 1 & {ω}_{8}^{2} & - 1 & - {ω}_{8}^{2} & & & & \\ 1 & - {ω}_{8}^{2} & - 1 & {ω}_{8}^{2} & & & & \\ & & & & - 1 & - {ω}_{8} & - {ω}_{8}^{2} & {ω}_{8}^{3} \\ & & & & - 1 & {ω}_{8} & - {ω}_{8}^{2} & {ω}_{8}^{3} \\ & & & & - 1 & - {ω}_{8}^{3} & {ω}_{8}^{2} & - {ω}_{8} \\ & & & & - 1 & {ω}_{8}^{3} & {ω}_{8}^{2} & {ω}_{8}\end{matrix} ] {\underbrace{[ \begin{matrix}1 & 1 \\ 1 & - 1\end{matrix} ] ⊗ {I}_{4}}}_{{A}_{3}} ,$$

in which the factor matrix A₃ is thus obtained. During the observation of a first submatrix after factorization, it can be understood that, the upper left and the lower right submatrices are structurally similar to the original P₈F₈ matrix. It may be further factorized as:

$${P}_{8} {F}_{8} = {\underbrace{[ \begin{matrix}1 & 1 & & & & & & \\ 1 & - 1 & & & & & & \\ & & 1 & {ω}_{8}^{2} & & & & \\ & & 1 & - {ω}_{8}^{2} & & & & \\ & & & & 1 & {ω}_{8} & & \\ & & & & 1 & - {ω}_{8} & & \\ & & & & & & 1 & {ω}_{8}^{3} \\ & & & & & & 1 & - {ω}_{8}^{3}\end{matrix} ]}}_{{A}_{1}} {\underbrace{[ \begin{matrix}1 & 1 & & \\ 1 & - 1 & & \\ & & 1 & {ω}_{8}^{2} \\ & & 1 & - {ω}_{8}^{2}\end{matrix} ] ⊗ {I}_{2}}}_{{A}_{2}} {A}_{3 ,}$$

in which factor matrices A₁ and A₂ are thus obtained. Using the properties of the permutation matrix P₈P₈=I₈ and multiplying P₈ to both sides of the above equation, the sparse factorization of the 8-DFT is obtained as F₈=P₈A₁A₂A₃, where the factor matrix includes complex elements ω₈=(1−j)/\sqrt{2},

$${ω}_{8}^{2} = - j , {ω}_{8}^{3} = - ( 1 + j ) / \sqrt{2} ,$$

where ω₈ and

$${ω}_{8}^{3}$$

do not fall into the feasible set while

$${ω}_{8}^{2}$$

does fall into the feasible set. ω₈ and

$${ω}_{8}^{3}$$

exist only in the factor matrix A₁. Next, the matrix A₁ is approximated using the feasible sets P={0, ±1, ±2, . . . , ±2^{q}} or

$$N = \{ 0 , \pm \frac{1}{2} , \pm 1 \} .$$

When using the feasible set P={0, ±1, ±2, . . . , ±2^{q}}, A₁ is mapped as

$${Â}_{1} = {f}_{P =} ( {A}_{1} ) = blk diag ( [ \begin{matrix}1 & 0 \\ 0 & 1\end{matrix} ] , [ \begin{matrix}1 & - j \\ 1 & j\end{matrix} ] , [ \begin{matrix}1 & 1 - j \\ 1 & - 1 + j\end{matrix} ] , [ \begin{matrix}1 & - 1 - j \\ 1 & 1 + j\end{matrix} ] ) .$$

The corresponding calibration matrix is given by

$${\overline{H}}_{1} = {A}_{1} {Â}_{1}^{1} = blk diag [ \begin{matrix}1 & 0 \\ 0 & 1\end{matrix} ] , [ \text{} \begin{matrix}1 & 0 \\ 0 & 1\end{matrix} ] , [ \begin{matrix}0.8536 & 0.1464 \\ 01464 & 08536\end{matrix} ] , [ \begin{matrix}0.8536 & 0.1464 \\ 01464 & 08536\end{matrix} ] ) .$$

Based on a minimum element in H̅₁, the scaling factor is obtained as α₁=2^{┌-log}^{₂}^{0.1464┐}=8. Based on the scaling factor, the calibration matrix

$${\hat{H}}_{1} = {f}_{P =} ( {\overline{H}}_{1} ) = blk diag ( [ \begin{matrix}8 & 0 \\ 0 & 8\end{matrix} ] , [ \begin{matrix}8 & 0 \\ 0 & 8\end{matrix} ] , [ \begin{matrix}8 & 1 \\ 1 & 8\end{matrix} ] , [ \begin{matrix}8 & 1 \\ 1 & 8\end{matrix} ] )$$

under constraints of the feasible set is obtained. The scaling factor \hat{β} is obtained from

$$\hat{β} = Re ( \frac{T r ( {F}_{8}^{†} {P}_{8} {G}_{8} )}{T r ( {G}_{8}^{†} {G}_{8} )} ) = 0.1137$$

with G₈=Ĥ₁Â₁A₂A₃. Finally, the approximate factorization of the 8-DFT matrix is given by \hat{F}₈=\hat{β}P₈Ĥ₁Â₁A₂A₃. The approximation error is 0.0082, and the orthogonality index is 0.0030, as shown in FIG. 2.

When using the feasible set

$$N = \{ 0 , \pm \frac{1}{2} , \pm 1 \} ,$$

A₁ is mapped as

$${Â}_{1} = {f}_{N =} ( {A}_{1} ) = blk diag ( [ \begin{matrix}1 & 1 \\ 1 & 1\end{matrix} ] , [ \begin{matrix}1 & - j \\ 1 & j\end{matrix} ] , [ \begin{matrix}1 & 1 / 2 - 1 / 2 j \\ 1 & - 1 / 2 + 1 / 2 j\end{matrix} ] , [ \begin{matrix}1 & - 1 / 2 - 1 / 2 j \\ 1 & 1 / 2 + 1 / 2 j\end{matrix} ] ) .$$

The scaling factor \hat{β} is given by

$$\hat{β} = Re ( \frac{T r ( {F}_{8}^{†} {P}_{8} {G}_{8} )}{T r ( {G}_{8}^{†} {G}_{8} )} ) = 1.0592$$

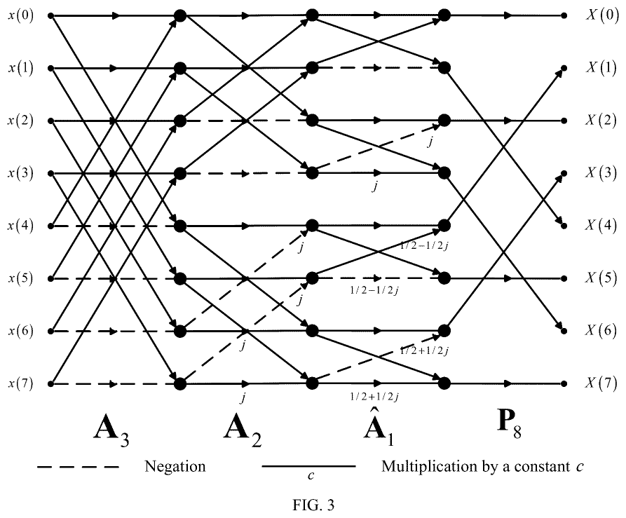

with G₈=Â₁A₂A₃. Finally, the approximate factorization of the 8-DFT is \hat{F}₈=\hat{β}P₈Â₁A₂A₃. The approximation error is 0.0184, and orthogonality index is 0.0194. The corresponding signal flow diagram is shown in FIG. 3.

OFDM is a modulation technology widely applied in high-speed communication systems, which may divide the available bandwidth into multiple subcarriers to achieve efficient data transmission. DFT plays a key role in OFDM systems. DFT may convert data into the frequency domain, enabling information to be modulated onto orthogonal subcarriers. This conversion ensures the orthogonality of the subcarriers, reduces interference, and improves spectral efficiency.

However, existing DFT approximation methods are mainly based on the idea of matrix decomposition and quantization mapping. Firstly, the DFT matrix is decomposed into multiple smaller matrices, then these matrices are subjected to quantization mapping, and finally an optimization problem is solved to obtain an approximate DFT matrix. Although this method can improve the computational efficiency to some extent, it still has several problems. For example, existing DFT approximation methods still exhibit high computational complexity when dealing with large-scale data and thus are unsuitable for real-time processing. In addition, the existing methods may lead to some numerical errors during the quantized mapping process, which may accumulate and thus affect the accuracy of the final results. Further, the existing methods do not make full use of the properties of sparse matrices when dealing with sparse matrices, thus requiring the OFDM system to have better hardware, which means there is still room for further improvement in computational efficiency.

To better understand the present disclosure, the OFDM system provided by the present disclosure is introduced below.

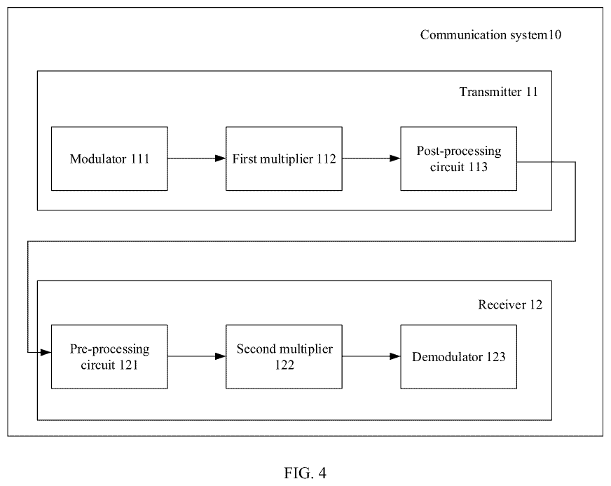

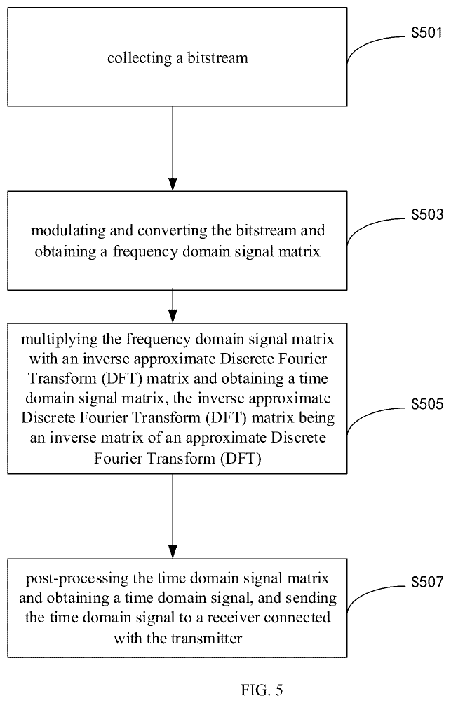

As shown in FIG. 4, FIG. 4 is a schematic structural view of a communication system in some embodiments of the present disclosure. A communication system 10 may be an OFDM system. The communication system includes a transmitter 11 and a receiver 12. The transmitter 11 includes a modulator 111, a first multiplier 112, and a post-processing circuit 113, the modulator 111 being connected to an input end of the transmitter 11, the first multiplier 112 being connected to an output end of the modulator 111, and the post-processing circuit 113 being connected to an output end of the first multiplier 112. The modulator 111 is configured to modulate and convert the bitstream obtained by the transmitter 11 and obtain a frequency domain signal matrix. The first multiplier 112 is configured to multiply the frequency domain signal matrix with an inverse approximate DFT matrix to obtain a time domain signal matrix, the inverse approximate Discrete Fourier Transform (DFT) matrix being an inverse matrix of an approximate Discrete Fourier Transform (DFT). The post-processing circuit 113 is configured to post-process the time domain signal matrix and obtain a time domain signal, and send the first domain signal to the receiver 12 connected with the transmitter 11. The receiver 12 includes a pre-processing circuit 121, a second multiplier 122, and a demodulator 123; the pre-processing circuit 121 is connected to an input end of the receiver 12; the second multiplier 122 is connected to an output end of the pre-processing circuit 121; the demodulator 123 is connected to an output end of the second multiplier 122. The pre-processing circuit 121 is configured to pre-process a time domain signal received from a transmitter connected with the receiver 12 and obtain a time domain signal matrix. The second multiplier 122 is configured to multiply the time domain signal matrix with an approximate DFT matrix and obtain a frequency domain signal matrix. The demodulator 123 is configured to demodulate and convert the frequency domain signal matrix and obtain a bitstream.

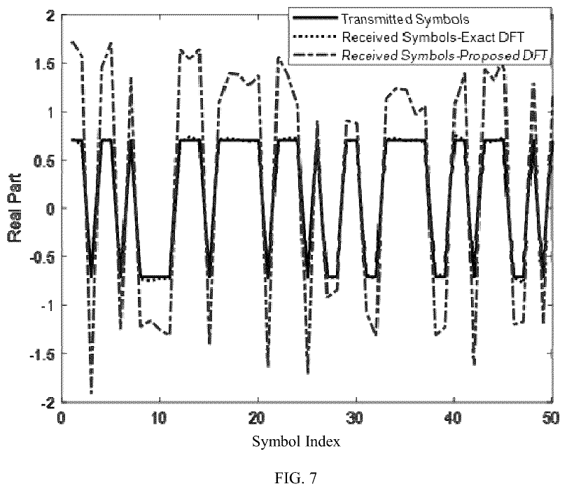

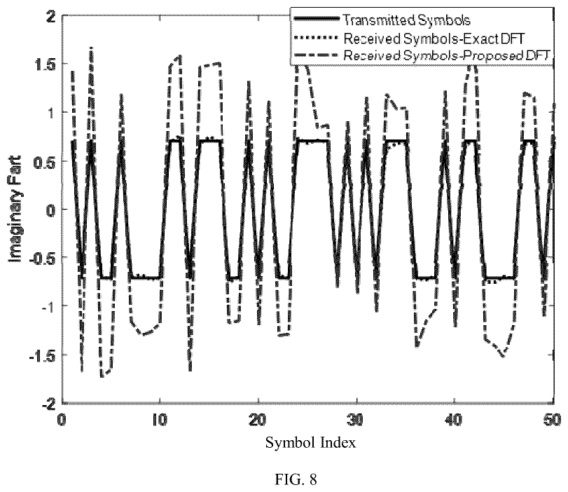

As shown in FIGS. 7 and 8, FIGS. 7 and 8 are schematic waveform graphs of a communication system in some embodiments of the present disclosure. In FIGS. 7 and 8, we test the performance of the OFDM system in some embodiments of the present disclosure by employing QPSK modulation with N=64 subcarriers over an additive white gaussian noise (AWGN) channel. It can be seen that the received symbols decoded using the OFDM system provided in some embodiments of the present disclosure exhibit accurate recovery, confirming both the high approximation precision and near-orthogonality preservation of the DFT approximation method.

As shown in FIG. 5, FIG. 5 is a schematic flowchart of a communication method in some embodiments of the present disclosure. The communication method is applied to the transmitter 11 of the communication system 10 described above, including the following operations.

S501: collecting a bitstream;

S503: modulating and converting the bitstream and obtaining a frequency domain signal matrix;

S505: multiplying the frequency domain signal matrix with an inverse approximate Discrete Fourier Transform (DFT) matrix and obtaining a time domain signal matrix, the inverse approximate Discrete Fourier Transform (DFT) matrix being an inverse matrix of an approximate Discrete Fourier Transform (DFT);

S507: post-processing the time domain signal matrix and obtaining a time domain signal, and sending the time domain signal to a receiver 12 connected with the transmitter 11.

A bitstream is collected. The bitstream refers to a binary data sequence obtained after digitization of information. Its source may be a digitized audio signal, a digitized video signal, etc. For example, after a voice signal undergoes sampling, quantization, and encoding, a binary bitstream is generated, and this bitstream carries the digitized information of the voice.

The bitstream is modulated and converted, and a frequency domain signal matrix is obtained. Common modulation methods include quadrature phase shifting keying (QPSK), etc. Through modulation, the bitstream may be converted into an analog signal suitable for transmission on OFDM subcarriers. For example, a 1024-bit bitstream is converted into 512 complex symbols through QPSK modulation, thereby forming a frequency domain signal matrix. The modulated signal is in serial form. In order to transmit data in parallel on multiple subcarriers in subsequent operations, a serial-to-parallel conversion is also required. For example, in an OFDM system with N subcarriers, the serial signal will be divided into N path of parallel signals, with each path corresponding to one subcarrier.

The frequency domain signal matrix is multiplied with an inverse approximate DFT matrix to obtain a time domain signal matrix, the inverse approximate Discrete Fourier Transform (DFT) matrix being an inverse matrix of an approximate Discrete Fourier Transform (DFT).

The time domain signal matrix is post-processed, and a time domain signal is obtained, and the time domain signal is sent to a receiver 12 connected with the transmitter 11.

In some embodiments of the present disclosure, the transmitter 11 obtains a time domain signal matrix by multiplying the frequency domain signal matrix with an inverse approximate DFT matrix, which reduces interference and improves spectral efficiency. Meanwhile, by using the inverse approximate DFT matrix, it improves computational efficiency while reducing the hardware requirements in the OFDM system.

In some embodiments, determining the inverse approximate DFT matrix includes: determining an approximate DFT matrix; performing conjugate transpose on the approximate DFT matrix and dividing by N to obtain the inverse approximate DFT matrix.

The approximate DFT matrix, by introducing sparse matrices and quantization mapping, the present disclosure significantly reduces the computational complexity of DFT matrix approximation. This enables real-time DFT computation even when processing large-scale data. Existing DFT approximation methods that are not tailored for specific point often rely on exhaustive search techniques. However, these methods become computationally prohibitive when the DFT point increases, making them unsuitable for large-scale data processing. In contrast, the present disclosure only requires computing a small number of closed-form expressions to obtain the approximate DFT matrix, thereby maintaining low computational complexity even for large-scale data. Furthermore, the present disclosure fully utilizes the properties of sparse matrices, further improving computational efficiency.

The approximate DFT matrix introduces calibration matrices and scaling parameters during the quantization mapping process, which effectively reduces numerical errors and improves the accuracy of the results. In addition, the optimization problem further optimizes the results, enabling the accuracy to be higher.

The DFT approximation matrix provided by the present disclosure is not only suitable for general DFT computations but also for DFT matrices with special structures such as bit-reversed order DFT matrices. Existing DFT approximation methods are often designed for DFT matrices of specific sizes. In contrast, the proposed method is applicable to DFT matrices of any size (integer powers of 2), offering greater universality.

The approximate DFT matrix provided by the present disclosure by introducing sparse matrices and quantization mapping, simplifies the computation process and enables it to be easier to implement. In addition, the detailed algorithmic steps provided in the present disclosure enable developers to implement the present disclosure easily. The DFT approximation results provided by the proposed method contain no irrational numbers, and the hardware implementation does not require any multipliers, significantly reducing the hardware complexity of DFT realization.

Overall, compared to related arts, the present disclosure offers higher computational efficiency, greater accuracy, broader applicability, and easier implementation, which makes it a superior method for DFT approximation.

The approximate DFT matrix in the present disclosure performs well in terms of approximation accuracy and orthogonality.

In some embodiments, the determining the approximate DFT matrix includes:
constructing a sparse factor matrix F_{N} of an N-point DFT matrix, where N is a power of two integer, based on a symmetric structure of the DFT matrix, where:

$${F}_{N , ( k , i )} = {ω}_{N}^{( k - 1 ) ( i - 1 )} ,$$

k=1, 2, . . . , N, i=1, 2, . . . , N where ω_{N}=e^{-j2π/N} is a Nth unit root, j=\sqrt{−1} is an imaginary unit,

$${ω}_{N}^{( k - 1 ) ( i - 1 )}$$

represents a (k−1)(i−1)th power of ω_{N}, and F_{N,(k,i)} represents a (k,i)th element of the matrix F_{N}; factorizing the sparse factor matrix F_{N} of the N-point DFT matrix by a formula of:

$${F}_{N} = {P}_{N} {\prod }_{i = 1}^{t} {A}_{i} ,$$

where t=log₂N, and P_{N} is a bit-reversal order permutation matrix, in a case where the bit-reversal order permutation matrix P_{N}=[eᵣ_{_{N,(1)}}, eᵣ_{_{N,(2)}}, . . . eᵣ_{_{N,(N)}}] as a bit-reversed sequence is r_{N}, where eₗ is a l+1th column of a N×N unit matrix, r_{N,(l)} is a lth element of r_{N}, Aᵢ is expressed as

$${A}_{i} = blk diag ( [ \begin{matrix}1 & {ω}_{N}^{{r}_{N , ( 1 )}} \\ 1 & {ω}_{N}^{{r}_{N , ( 2 )}}\end{matrix} ] [ \begin{matrix}1 & {ω}_{N}^{{r}_{N , ( 3 )}} \\ 1 & {ω}_{N}^{{r}_{N , ( 4 )}}\end{matrix} ] , … , [ \begin{matrix}1 & {ω}_{N}^{{r}_{N , ( {2}^{( t - i + 1 )} - 1 )}} \\ 1 & {ω}_{N}^{{r}_{N , ( {2}^{( t - i + 1 )} - 1 )}}\end{matrix} ] ⊗ {I}_{{2}^{i - 1}} , \qquad ( 1 )$$

where blkdiag(·) denotes a block diagonal matrix comprising specified matrices on a diagonal of the block diagonal matrix, ⊗ is a Kronecker product operation, and r_{N,(l)} is a lth element of r_{N}; mapping the matrix Aᵢ to a first feasible set P={0, ±1, ±2, . . . , ±2^{q}} and obtaining a first quantized-mapping factor matrix Âᵢ; performing amplitude calibration and phase calibration on the first quantized-mapping factor matrix and obtaining a first mapped-calibrated factor matrix ĤᵢÂᵢ, such that a mapped-calibrated sparse factor matrix is obtained; obtaining the approximate DFT matrix by applying a real scaling factor β and optimizing the mapped-calibrated sparse factor matrix, where the approximate DFT matrix

$${\hat{F}}_{N} = \hat{β} {\prod }_{i = 1}^{t - 2} {\hat{H}}_{i} {Â}_{i} {A}_{t - 1} {A}_{t} ;$$

where

$$\hat{β} = Re ( \frac{T r ( {F}_{N}^{†} {P}_{N} {G}_{N} )}{T r ( {G}_{N}^{†} {G}_{N} )} ) .$$

A sparse factor matrix F_{N} of an N-point DFT matrix is constructed. A DFT sample X=[X(0), X(1), . . . , X(N−1)]^{T} of the time-domain signal x=[x(0), x(1), . . . , x(N−1)]^{T} may be expressed as X=F_{N}x.

The sparse factor matrix F_{N} of the N-point DFT matrix F_{N} is factorized by a formula. Taking N=8 as an example, when the natural order sequence is {0,1,2,3,4,5,6,7}, its binary representation is {000,001,010,011,100,101,110,111}. Then the bit-reversed binary representation is {000,100,010,110,001,101,011,111}. The bit-reversed sequence is thus obtained as {0,4,2,6,1,5,3,7}. Based on the bit-reversed sequence, the bit-reversal order permutation matrix in this case is P₈=[e₀,e₄,e₂,e₆,e₁,e₅,e₃,e₇]. Each Aᵢ is a full-rank N×N sparse matrix. By putting the bit-reversed order sequence into an N×1 vector, we obtain r_{N}. Aᵢ can be expressed as

$${A}_{i} = blkdiag ( [ \begin{matrix}1 & {ω}_{N}^{{r}_{N , ( 1 )}} \\ 1 & {ω}_{N}^{{r}_{N , ( 2 )}}\end{matrix} ] , [ \begin{matrix}1 & {ω}_{N}^{{r}_{N , ( 3 )}} \\ 1 & {ω}_{N}^{{r}_{N , ( 4 )}}\end{matrix} ] , … , [ \begin{matrix}1 & {ω}_{N}^{{r}_{N , ( {2}^{( t - i + 1 )} - 1 )}} \\ 1 & {ω}_{N}^{{r}_{N , ( {2}^{( t - i + 1 )} )}}\end{matrix} ] ) ⊗ {I}_{{2}^{i - 1}} .$$

The matrix Aᵢ is mapped to a first feasible set P={0, ±1, ±2, . . . , ±2^{q}} and a first quantized factor matrix: Âᵢ=ƒ_{P=}(Aᵢ) is obtained, where q is a non-negative integer.

Amplitude calibration and phase calibration are performed on the first quantized-mapping factor matrix and a first calibrated factor matrix HᵢÂᵢ is obtained, such that a mapped-calibrated sparse factor matrix is obtained.

An approximate DFT matrix is obtained by applying a real scaling factor β to optimize the sparse factor matrix F_{N} that is mapped and calibrated. For example, let

$${G}_{N} = {\prod }_{i = 1}^{t - 2} {\hat{H}}_{i} {\hat{A}}_{i} {A}_{t - 1} {A}_{t} ,$$

then a least squares problem

$$\hat{β} = arg {min}_{β} {‖ β {P}_{N} {G}_{N} - {F}_{N} ‖}_{F}^{2}$$

is constructed. The optimal solution of the least squares problem may be expressed by a closed-form expression

$$\hat{β} = Re ( \frac{T r ( {F}_{N}^{†} {P}_{N} {G}_{N} )}{T r ( {G}_{N}^{†} {G}_{N} )} ) .$$

Finally, the approximate result of the N-point DFT matrix is

$${\hat{F}}_{N} = \hat{β} {\prod }_{i = 1}^{t - 2} {\hat{H}}_{i} {\hat{A}}_{i} {A}_{t - 1} {A}_{t} .$$

In some embodiments, the determining the approximate DFT matrix includes:
constructing a sparse factor matrix F_{N} of an N-point DFT matrix based on a symmetric structure of the DFT matrix, where

$${F}_{N , ( k , i )} = {ω}_{N}^{( k - 1 ) ( i - 1 )} ,$$

k=1, 2, . . . , N, i=1, 2, . . . , N, where ω_{N}=e^{-j2π/N} is a Nth unit root, j=\sqrt{−1} is an imaginary unit,

$${ω}_{N}^{( k - 1 ) ( i - 1 )}$$

represents a (k−1)(i−1)th power of ω_{N}, and F_{N,(k,i)} represents a (k,i)th element of the matrix F_{N}; factorizing the sparse factor matrix F_{N} of the N-point DFT matrix by a formula of:

$${F}_{N} = {P}_{N} {\prod }_{i = 1}^{t} {A}_{i} ,$$

where t=log₂ N, and P_{N} is a bit-reversal order permutation matrix, in a case where the bit-reversal order permutation matrix P_{N}=[eᵣ_{_{N,(1)}}, eᵣ_{_{N,(2)}}, . . . eᵣ_{_{N,(N)}}] as a bit-reversed sequence is r_{N}, where eₗ is a l+1th column of a N×N unit matrix, r_{N,(l)} is a lth element of r_{N}, Aᵢ is expressed as

$${A}_{i} = blkdiag ( [ \begin{matrix}1 & {ω}_{N}^{{r}_{N , ( 1 )}} \\ 1 & {ω}_{N}^{{r}_{N , ( 2 )}}\end{matrix} ] , [ \begin{matrix}1 & {ω}_{N}^{{r}_{N , ( 3 )}} \\ 1 & {ω}_{N}^{{r}_{N , ( 4 )}}\end{matrix} ] , … , [ \begin{matrix}1 & {ω}_{N}^{{r}_{N , ( {2}^{( t - i + 1 )} - 1 )}} \\ 1 & {ω}_{N}^{{r}_{N , ( {2}^{( t - i + 1 )} )}}\end{matrix} ] ) ⊗ {I}_{{2}^{i - 1}} ,$$

wherein blkdiag(·) denotes a block diagonal matrix including specified matrices on a diagonal of the block diagonal matrix, ⊗ is a Kronecker product operation, and r_{N,(l)} is a lth element of r_{N}, mapping the matrix Aᵢ to a second feasible set

$$N = \{ 0 , \pm \frac{1}{2} , \pm 1 \}$$

and obtaining a second quantized-mapping factor matrix Âᵢ; performing amplitude calibration and phase calibration on the second quantized-mapping factor matrix and obtaining a second mapped-calibrated factor matrix ĤᵢÂᵢ, such that a mapped-calibrated sparse factor matrix is obtained; obtaining the approximate DFT matrix by applying a real scaling factor β and optimizing the mapped-calibrated sparse factor matrix, where the approximate DFT matrix

$${\hat{F}}_{N} = \hat{β} {\prod }_{i = 1}^{t - 2} {\hat{H}}_{i} {\hat{A}}_{i} {A}_{t - 1} {A}_{t} ; where \hat{β} = Re ( \frac{T r ( {F}_{N}^{†} {P}_{N} {G}_{N} )}{T r ( {G}_{N}^{†} {G}_{N} )} ) .$$

Taking N=8 as an example, when the natural order sequence is {0,1,2,3,4,5,6,7}, its binary representation is {000,001,010,011,100,101,110,111}. Then the bit-reversed binary representation is {000,100,010,110,001,101,011,111}. The bit-reversed sequence is thus obtained as {0,4,2,6,1,5,3,7}. Based on the bit-reversed sequence, the bit-reversal order permutation matrix in this case is P₈=[e₀,e₄,e₂,e₆,e₁,e₅,e₃,e₇]. Each Aᵢ is a full-rank N×N sparse matrix. By putting the bit-reversed order sequence into an N×1 vector, we obtain r_{N}. Aᵢ can be expressed as

$${A}_{i} = blkdiag ( [ \begin{matrix}1 & {ω}_{N}^{{r}_{N , ( 1 )}} \\ 1 & {ω}_{N}^{{r}_{N , ( 2 )}}\end{matrix} ] , [ \begin{matrix}1 & {ω}_{N}^{{r}_{N , ( 3 )}} \\ 1 & {ω}_{N}^{{r}_{N , ( 4 )}}\end{matrix} ] , … , [ \begin{matrix}1 & {ω}_{N}^{{r}_{N , ( {2}^{( t - i + 1 )} - 1 )}} \\ 1 & {ω}_{N}^{{r}_{N , ( {2}^{( t - i + 1 )} )}}\end{matrix} ] ) ⊗ {I}_{{2}^{i - 1}} ,$$

where blkdiag(·) denotes a block diagonal matrix including specified matrices on a diagonal of the block diagonal matrix, ⊗ is the Kronecker product operation, and r_{N,(l)} is a lth element of r_{N}.

In some embodiments, when using the first feasible set, the performing amplitude calibration and phase calibration on the first quantized-mapping factor matrix and obtaining a first mapped-calibrated factor matrix ĤᵢÂᵢ, such that a mapped-calibrated sparse factor matrix is obtained includes:
constructing a least squares calibration matrix

$${\overline{H}}_{i} = arg {min}_{{H}_{i}} {‖ {H}_{i} {\hat{A}}_{i} - {A}_{i} ‖}_{F}^{2} ,$$

where ∥·∥_{F} is the Frobenius norm, and Hᵢ is a calibration matrix; mapping the least squares calibration matrix to the first feasible set and obtaining a first calibrated factor matrix Ĥᵢ; calibrating the first quantized-mapping factor matrix Âᵢ based on first calibrated factor matrix Ĥᵢ and obtaining the first mapped-calibrated factor matrix ĤᵢÂᵢ.

As the constraints of the feasible set are discrete constraints, which are hard to be directly processed, these constraints may be temporarily abandoned first. Instead, a least squares problem

$${\overline{H}}_{i} = arg {min}_{{H}_{i}} {‖ {H}_{i} {\hat{A}}_{i} - {A}_{i} ‖}_{F}^{2} ,$$

may be constructed, enabling the matrix HᵢÂᵢ after calibration approximates the original matrix Aᵢ, where ∥·∥_{F} is the Frobenius norm. The optimal solution to a least squares problem can be obtained directly by H̅ᵢ=AᵢÂᵢ⁻¹. It should be noted that both Aᵢ and Âᵢ are sparse matrices, and the specific structure of the sparse matrix enables positions of non-zero elements in Âᵢ⁻¹ be the same as that in Aᵢ. Therefore, they still are sparse matrices that have no more than 2 non-zero elements in each column and each row.

H̅ᵢ may include an element that is not in the feasible set, which thus needs to be mapped. Since the non-zero elements of Aᵢ are always located on the unit circle and the non-zero elements of Âᵢ are always located on or outside the unit circle, making the elements of H̅ᵢ always located on or within the unit circle.

When using the first feasible set P={0, ±1, ±2, . . . , ±2^{q}}, if the non-zero elements in H̅ᵢ are mapped directly, the elements after mapping may be limited to −1, 0, or 1, resulting to too large error of approximation. To address this issue, a scaling parameter αᵢ is introduced before mapping H̅ᵢ, where αᵢ is decided by the minimum absolute value of the non-zero elements in H̅ᵢ. Let εᵢ be the minimum absolute value of the non-zero elements H̅ᵢ, then αᵢ=2^{┌-log}^{₂}^{ε}^{ᵢ}^{┐}. H̅ᵢ is mapped as Ĥᵢ=ƒ_{P=}(αᵢH̅ᵢ), ensuring the minimum value in H̅ᵢ is mapped to ±1, which may have an effective calibration on each element of Âᵢ.

In some embodiments, when using the second feasible set

$$N = \{ 0 , \pm \frac{1}{2} , \pm 1 \} ,$$

the performing amplitude calibration and phase calibration on the second quantized-mapping factor matrix and obtaining a second mapped-calibrated factor matrix ĤᵢÂᵢ, such that a mapped-calibrated sparse factor matrix is obtained includes:
constructing a least squares calibration matrix

$${\overline{H}}_{i} = arg {min}_{{H}_{i}} {‖ {H}_{i} {\hat{A}}_{i} - {A}_{i} ‖}_{F}^{2} ,$$

where ∥·∥_{F} is the Frobenius norm, and Hᵢ is a calibration matrix; mapping the least squares calibration matrix to the first feasible set and obtaining a second calibrated factor matrix Ĥᵢ; calibrating the second quantized-mapping factor matrix Âᵢ based on second calibrated factor matrix Ĥᵢ and obtaining the second mapped-calibrated factor matrix ĤᵢÂᵢ.

When using the second feasible set

$$N = \{ 0 , \pm \frac{1}{2} , \pm 1 \} ,$$

H̅ᵢ is mapped as Ĥᵢ=ƒ_{N=}(αᵢH̅ᵢ). The process of performing calibration using the second feasible set is similar to the process of performing calibration using the first feasible set, which will not be repeated here.

In some embodiments, the mapping the matrix Aᵢ to a first feasible set P={0, ±1, ±2, . . . , ±2^{q}}, where q is a non-negative integer, and obtaining a first quantized-mapping factor matrix Âᵢ, includes:
mapping, in condition of all elements in a matrix Aₜ₋₁ and a matrix Aₜ satisfying constraints of the first feasible set, rest of matrices Aᵢ to the first feasible set.

When using the first feasible set P={0, ±1, ±2, . . . , ±2^{q}}, all the elements in Aₜ₋₁ and Aₜ satisfy constraints of the feasible set. Therefore, there is no need to perform a mapping operation. The real and imaginary parts of elements of rest matrices Aᵢ are not always in the feasible set and thus needs to perform the mapping operation, which are replaced with closest values from the feasible set. A mapping function may be ƒ_{P=}(·) when using P={0, ±1, ±2, . . . , ±₂^{q}} as the feasible set, such that an approximation result of Aᵢ is Âᵢ=ƒ_{P=}(Aᵢ).

In some embodiments, the mapping the matrix Aᵢ to a second feasible set

$$N = \{ 0 , \pm \frac{1}{2} , \pm 1 \}$$

and obtaining a second quantized-mapping factor matrix Âᵢ, includes:
mapping, in condition of all elements in a matrix Aₜ₋₁, and a matrix Aᵢ satisfying constraints of the second feasible set, rest of matrices Aᵢ to the second feasible set.

When using the second feasible set

$$N = \{ 0 , \pm \frac{1}{2} , \pm 1 \} ,$$

all the elements in Aₜ₋₁ and Aᵢ satisfy constraints of the feasible set. Therefore, there is no need to perform a mapping operation. The real and imaginary parts of elements of rest matrices Aᵢ are not always in the feasible set and thus needs to perform the mapping operation, which are replaced with closest values from the feasible set. A mapping function may be ƒ_{N=}(·) when using

$$N = \{ 0 , \pm \frac{1}{2} , \pm 1 \}$$

as the feasible set, such that an approximation result of Aᵢ is Âᵢ=ƒ_{N=}(Aᵢ).

In some embodiments, the post-processing the time domain signal matrix to obtain the time domain signal includes the following.

A cyclic prefix is added. For example, in order to combat inter-symbol interference caused by multipath fading, a cyclic prefix is added before each symbol of the time domain signal matrix. For example, when a length of the cyclic prefix is set to 32, the last 32 sampling points of each symbol are copied to the front of the symbol, forming a new time domain signal matrix.

A parallel-to-serial conversion is performed. For example, after the cyclic prefix is added, the time domain signal matrix is subjected to parallel-to-serial conversion column by column, converting parallel data into a serial data stream for subsequent transmission.

A digital-to-analog conversion is performed. The digital-to-analog conversion may convert the digital signal after parallel-to-serial conversion into an analog signal through a digital-to-analog converter (DAC).

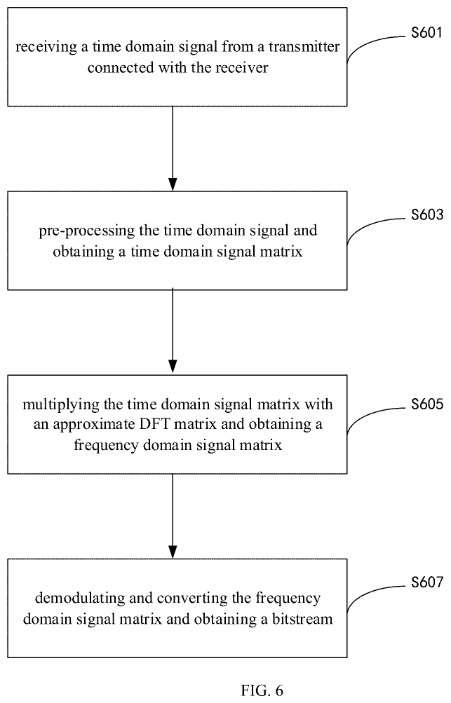

As shown in FIG. 6, FIG. 6 is a schematic flowchart of a communication method in some embodiments of the present disclosure. The communication method is applied to the receiver 12 of the communication system 10 described above, including the following operations.

S601: receiving a time domain signal from a transmitter connected with the receiver;

S603: pre-processing the time domain signal and obtaining a time domain signal matrix;

S605: multiplying the time domain signal matrix with an approximate DFT matrix and obtaining a frequency domain signal matrix;

S607: demodulating and converting the frequency domain signal matrix and obtaining a bitstream.

A time domain signal from a transmitter 11 connected to the receiver 12 is received. The receiver 12 may receive the time domain signal from the transmitter 11 via an antenna.

In some embodiments, the receiver 12 multiplies the time domain signal matrix with an approximate DFT matrix and obtain a frequency domain signal matrix, which reduces interference and improves spectral efficiency. Meanwhile, by using the approximate DFT matrix, computational efficiency is provided while reducing hardware requirements in the OFDM system.

The time domain signal is pre-processed and a time domain signal matrix is obtained;

The time domain signal matrix is multiplied with an approximate DFT matrix and a frequency domain signal matrix is obtained.

The frequency domain signal matrix is demodulated and converted, and a bitstream is obtained.

FIG. 2 is a signal flow diagram of an 8-point DFT approximation by using a feasible set P={0, ±1, ±2, . . . ±2^{q}}. FIG. 3 is a signal flow diagram of an 8-point DFT approximation by using a feasible set

$$N = \{ 0 , \pm \frac{1}{2} , \pm 1 \} .$$

It can be seen that the signal flow diagram obtained in the present disclosure is different from the traditional DFT signal flow diagram and is not a fully connected structure. In the traditional DFT signal flow diagram, each computation node needs to be processed individually, and there is a large amount of redundant computation. Therefore, during hardware implementation, due to the large resource consumption and slow operation speed of complex multipliers, the overall computation efficiency is limited, making it difficult to meet the real-time requirements of applications with high real-time demands, such as the OFDM communication system of the present disclosure.

The present application simplifies the original complex DFT computation by adopting a decomposition computation method, thereby reducing the time complexity from the original O(N²) to a level close to FFT, i.e., O(N log N). Therefore, when performing DFT computation with the same number of points, the computation efficiency may be significantly improved, and the complexity and resource requirements for hardware implementation may also be reduced.

In addition, as mentioned above, in some embodiments of the present disclosure, as shown in FIG. 2, the approximation error of the 8-point DFT obtained using the feasible set P={0, ±1, ±2, . . . , ±2^{q}} is 0.0082, and its orthogonality index is 0.0030. As shown in FIG. 3, the approximation error of the 8-point DFT obtained using the feasible set

$$N = \{ 0 , \pm \frac{1}{2} , \pm 1 \}$$

is 0.0184, and its orthogonality index is 0.0194. It can be understood that the approximation error measures the degree of difference between the approximate DFT matrix obtained according to the communication method of the present disclosure and the precise DFT matrix. The smaller the error, the more accurately the approximate DFT matrix may represent the characteristics and computational results of the precise DFT matrix. It can also be understood that the orthogonality index reflects the degree of deviation of the approximate DFT matrix obtained according to the communication method of the present application from the ideal orthogonal state. The ideal orthogonality refers to the independence of different frequency components, where there is no interference between signals. The smaller the orthogonality index, the closer the approximate DFT matrix is to the ideal orthogonal state, and the smaller the interference between signals of different frequency components.

That is to say, after calculating the approximation error and orthogonality index of the approximate DFT matrix obtained using the feasible set

$$N = \{ 0 , \pm \frac{1}{2} , \pm 1 \} ,$$

and the approximation error and orthogonality index of the approximate DFT matrix obtained using the feasible set P={0, ±1, ±2, . . . , 2^{q}}, an approximate DFT matrix with a smaller approximation error or smaller orthogonality index may be selected according to an actual communication environment, so as to better improve the stability of the communication system.

The above descriptions of the various embodiments tend to emphasize the differences between the respective embodiments. Their similarities or commonalities may be referenced from one another and will not be redundantly described herein for the sake of brevity.

In the several embodiments provided in the present disclosure, it should be understood that the disclosed methods and apparatuses may be implemented in other manners. For example, the device implementations described above are merely illustrative. For instance, the division of modules or units is merely one form of logical functional division. In actual implementation, other forms of division may be adopted, such as combining units or integrating them into another system, or certain features may be omitted or not executed. Additionally, the coupling or direct coupling or communication connections between the components as shown or discussed may be indirect coupling or communication connection via some interfaces, devices, or units, which may be in electrical, mechanical, or other forms.

Moreover, the functional units in each embodiment of the present disclosure may be integrated into one processing unit or may exist independently as separate physical units, or two or more units may be integrated into one unit. The integrated units may be implemented in hardware form or as software functional units.

If the integrated units are implemented as software functional units and sold or used as independent products, they may be stored in a computer-readable storage medium. Based on such understanding, the technical solutions of the present disclosure, in essence, or the parts that contribute to the prior art, or all or part of the technical solution, may be embodied in the form of software products. The computer software product is stored in a storage medium and includes a plurality of instructions to enable a computer device (which may be a personal computer, server, or network device, etc.) or a processor to execute all or part of the steps of the methods of the various embodiments of the present application. The above-mentioned storage medium includes: USB flash drive, mobile hard disk, read-only memory (ROM), random access memory (RAM), magnetic disk, optical disc, or other media capable of storing program codes.

Finally, it should be noted that the above embodiments are merely used to illustrate the technical solutions of the present disclosure and are not intended to limit them. Although the present disclosure is described in detail with reference to the foregoing embodiments, it should be understood by those of ordinary skill in the art that they may still modify the technical solutions described in the foregoing embodiments, or equivalently replace some or all of the technical features therein. Such modifications or replacements do not depart from the essence of the corresponding technical solutions of the embodiments of the present disclosure, and shall all be included within the scope of the claims and the specification of the present disclosure. In particular, as long as there is no structural conflict, the technical features mentioned in the various embodiments may be combined in any manner. The present disclosure is not limited to the specific embodiments disclosed herein but includes all technical solutions falling within the scope of the claims.

1. A communication method, applied to a transmitter, comprising:
collecting a bitstream;
modulating and converting the bitstream and obtaining a frequency domain signal matrix;
multiplying the frequency domain signal matrix with an inverse approximate Discrete Fourier Transform (DFT) matrix and obtaining a time domain signal matrix, the inverse approximate Discrete Fourier Transform (DFT) matrix being an inverse matrix of an approximate Discrete Fourier Transform (DFT);
post-processing the time domain signal matrix and obtaining a time domain signal, and sending the time domain signal to a receiver connected with the transmitter.

2. The method of claim 1, wherein determining the inverse approximate DFT matrix comprises:
determining the approximate DFT matrix;
performing conjugate transpose on the approximate DFT matrix and dividing by N to obtain the inverse approximate DFT matrix.

3. The method of claim 2, wherein the determining the approximate DFT matrix comprises:
constructing a sparse factor matrix F_{N} of an N-point DFT matrix, where N is a power of two integer, based on a symmetric structure of the DFT matrix, wherein
$${F}_{N , ( k , i )} = {ω}_{N}^{( k - 1 ) ( i - 1 )} ,$$
k=1, 2, . . . , N, i=1, 2, . . . , N,
wherein ω_{N}=e^{-j2π/N} is a Nth unit root, j=\sqrt{−1} is an imaginary unit,
$${ω}_{N}^{( k - 1 ) ( i - 1 )}$$
represents a (k−1)(i−1)th power of ω_{N}, and F_{N,(k,i)} represents a (k,i)th element of the matrix F_{N};
factorizing the sparse factor matrix F_{N} of the N-point DFT matrix by a formula of:
$${F}_{N} = {P}_{N} {\prod }_{i = 1}^{t} {A}_{i} ,$$
wherein t log₂N, and P_{N} is a bit-reversal order permutation matrix,
in a case where the bit-reversal order permutation matrix P_{N}=[eᵣ_{_{N,(1)}}, eᵣ_{_{N,(2)}}, . . . , eᵣ_{_{N,(N)}}] as a bit-reversed sequence is r_{N}, wherein eₗ is a l+1th column of a N×N unit matrix, r_{N,(l)} is a lth element of r_{N}, Aᵢ is expressed as
$${A}_{i} = blk diag [ \begin{matrix}1 & {ω}_{N}^{{r}_{N , ( 1 )}} \\ 1 & {ω}_{N}^{{r}_{N , ( 2 )}}\end{matrix} ] , [ \begin{matrix}1 & {ω}_{N}^{{r}_{N , ( 3 )}} \\ 1 & {ω}_{N}^{{r}_{N , ( 4 )}}\end{matrix} ] , … , [ \begin{matrix}1 & {ω}_{N}^{{r}_{N , ( {2}^{t - 1 + 1 )} - 1 )}} \\ 1 & {ω}_{N}^{{r}_{N , ( {2}^{t - 1 + 1 )} )}}\end{matrix} ] ) ⊗ {I}_{{2}^{i - 1}} ,$$
wherein bkdiag(·) denotes a block diagonal matrix comprising specified matrices on a diagonal of the block diagonal matrix, ⊗ is a Kronecker product operation, and r_{N,(l)} is a lth element of r_{N};
mapping the matrix Aᵢ to a first feasible set [symbol] ={0, ±1, ±2, . . . , ±2^{q}} for a non-negative integer q and obtaining a first quantized-mapping factor matrix Âᵢ;
performing amplitude calibration and phase calibration on the first quantized-mapping factor matrix and obtaining a first mapped-calibrated factor matrix ĤᵢÂᵢ, such that a mapped-calibrated sparse factor matrix is obtained;
obtaining the approximate DFT matrix by applying a real scaling factor β and optimizing the mapped-calibrated sparse factor matrix,
wherein the approximate DFT matrix
$${\hat{F}}_{N} = \hat{β} {{\prod }_{i = 1}}^{t - 2} {\hat{H}}_{i} {\hat{A}}_{i} {A}_{t - 1} {A}_{t} ;$$
wherein
$$\hat{β} = Re ( \frac{Tr ( {F}_{N}^{†} {P}_{N} {G}_{N} )}{Tr ( {G}_{N}^{†} {G}_{N} )} ) .$$

4. The method of claim 2, wherein the determining the approximate DFT matrix comprises:
constructing a sparse factor matrix F_{N} of an N-point DFT matrix, where N is a power of two integer, based on a symmetric structure of the DFT matrix, wherein
$${F}_{N , ( k , i )} = {ω}_{N}^{( k - 1 ) ( i - 1 )} ,$$
k=1, 2, . . . , N, i=1, 2, . . . , N,
wherein ω_{N}=e^{-j2π/N} is a Nth unit root, j=\sqrt{−1} is an imaginary unit,
$${ω}_{N}^{( k - 1 ) ( i - 1 )}$$
represents a (k−1)(i−1)th power of ω_{N}, and F_{N,(k,i)} represents a (k,i)th element of the matrix F_{N};
factorizing the sparse factor matrix F_{N} of the N-point DFT matrix by a formula of:
$${F}_{N} = {P}_{N} {\prod }_{i = 1}^{t} {A}_{i} ,$$
wherein t=log₂N, and P_{N} is a bit-reversal order permutation matrix,
in a case where the bit-reversal order permutation matrix P_{N}=[eᵣ_{_{N,(1)}}, eᵣ_{_{N,(2)}}, . . . , eᵣ_{_{N,(N)}}] as a bit-reversed sequence is r_{N}, wherein eₗ is a l+1th column of a N×N unit matrix, r_{N,(l)} is a lth element of r_{N}, Aᵢ is expressed as
$${A}_{i} = blk diag ( [ \begin{matrix}1 & {ω}_{N}^{{r}_{N , ( 1 )}} \\ 1 & {ω}_{N}^{{r}_{N , ( 2 )}}\end{matrix} ] , [ \begin{matrix}1 & {ω}_{N}^{{r}_{N , ( 3 )}} \\ 1 & {ω}_{N}^{{r}_{N , ( 4 )}}\end{matrix} ] , … , [ \begin{matrix}1 & {ω}_{N}^{{r}_{N , ( {2}^{( t - i + 1 )} - 1 )}} \\ 1 & {ω}_{N}^{{r}_{N , ( {2}^{( t - i + 1 )} )}}\end{matrix} ] ) ⊗ {I}_{{2}^{i - 1}} ,$$
wherein blkdiag(·) denotes a block diagonal matrix comprising specified matrices on a diagonal of the block diagonal matrix, ⊗ is a Kronecker product operation, and r_{N,(l)} is a lth element of r_{N};
mapping the matrix Aᵢ to a second feasible set
$$𝒩 = \{ 0 , \pm \frac{1}{2} , \pm 1 \}$$
and obtaining a second quantized-mapping factor matrix Âᵢ;
performing amplitude calibration and phase calibration on the second quantized-mapping factor matrix and obtaining a second mapped-calibrated factor matrix ĤᵢÂᵢ, such that a mapped-calibrated sparse factor matrix is obtained;
obtaining the approximate DFT matrix by applying a real scaling factor β to optimize the mapped-calibrated sparse factor matrix,
wherein the approximate DFT matrix
$${\hat{F}}_{N} = \hat{β} {{\prod }^{t - 2}}_{i = 1} {\hat{H}}_{i} {\hat{A}}_{i} {A}_{t - 1} {A}_{t} ;$$
$$wherein$$
$$\hat{β} = Re ( \frac{Tr ( {F}_{N}^{†} {P}_{N} {G}_{N} )}{Tr ( {G}_{N}^{†} {G}_{N} )} ) .$$

5. The method of claim 3, wherein the performing amplitude calibration and phase calibration on the first quantized-mapping factor matrix and obtaining a first mapped-calibrated factor matrix ĤᵢÂᵢ, such that a mapped-calibrated sparse factor matrix is obtained comprises:
constructing a least squares calibration matrix
$${\overline{H}}_{i} = arg {min}_{{H}_{i}} {‖ {H}_{i} {\hat{A}}_{i} - {A}_{i} ‖}_{F}^{2} ,$$
wherein ∥·∥_{F} is the Frobenius norm, and Hₗ is a calibration matrix;
mapping the least squares calibration matrix to the first feasible set and obtaining a first calibrated factor matrix Ĥᵢ;
calibrating the first quantized-mapping factor matrix Âᵢ based on first calibrated factor matrix Ĥᵢ and obtaining the first mapped-calibrated factor matrix ĤᵢÂᵢ.

6. The method of claim 4, wherein the performing amplitude calibration and phase calibration on the second quantized-mapping factor matrix and obtaining a second mapped-calibrated factor matrix ĤᵢÂᵢ, such that a mapped-calibrated sparse factor matrix is obtained comprises:
constructing a least squares calibration matrix
$${\overline{H}}_{i} = arg {min}_{{H}_{i}} {‖ {H}_{i} {\hat{A}}_{i} - {A}_{i} ‖}_{F}^{2} ,$$
wherein ∥·∥_{F} is the Frobenius norm, and Hᵢ is a calibration matrix;
calibrating the second quantized-mapping factor matrix Âᵢ based on second calibrated factor matrix Ĥᵢ and obtaining the second mapped-calibrated factor matrix ĤᵢÂᵢ.

7. The method of claim 3, wherein the mapping the matrix Aᵢ to a first feasible set [symbol] ={0, ±1, ±2, . . . , ±2^{q}} and obtaining a first quantized-mapping factor matrix Âᵢ, comprises:
mapping, in condition of all elements in a matrix Aₜ₋₁ and a matrix Aᵢ satisfying constraints of the first feasible set, rest of matrices Aᵢ to the first feasible set.

8. The method of claim 4, wherein the mapping the matrix Aᵢ to a second feasible set
$$𝒩 = \{ 0 , \pm \frac{1}{2} , \pm 1 \}$$
and obtaining a second quantized-mapping factor matrix Âᵢ, comprises:
mapping, in condition of all elements in a matrix Aₜ₋₁ and a matrix Aₜ satisfying constraints of the second feasible set, rest of matrices Aᵢ to the second feasible set.

9. The method of claim 1, wherein the post-processing the time domain signal matrix comprises:
adding a cyclic prefix;
performing a parallel-to-serial conversion;
performing a digital-to-analog conversion.

10. A communication method, applied to a receiver, comprising:
receiving a time domain signal from a transmitter connected with the receiver;
pre-processing the time domain signal and obtaining a time domain signal matrix;
multiplying the time domain signal matrix with an approximate DFT matrix and obtaining a frequency domain signal matrix;
demodulating and converting the frequency domain signal matrix and obtaining a bitstream.

11. The method of claim 10, wherein the pre-processing the time domain signal to obtain a time domain signal matrix comprises:
performing an analog-to-digital conversion;
removing a cyclic prefix;
performing a serial-to-parallel conversion.

12. The method of claim 10, wherein the determining the approximate DFT matrix comprises:
constructing a sparse factor matrix F_{N} of an N-point DFT matrix, where N is a power of two integer, based on a symmetric structure of the DFT matrix, wherein
$${F}_{N , ( k , i )} = {ω}_{N}^{( k - 1 ) ( i - 1 )} ,$$
k=1, 2, . . . , N, i=1, 2, . . . , N,
wherein ω_{N}=e^{-j2π/N} is a Nth unit root, j=\sqrt{−1} is an imaginary unit,
$${ω}_{N}^{( k - 1 ) ( i - 1 )}$$
represents a (k−1)(i−1)th power of ω_{N}, and F_{N,(k,i)} represents a (k,i)th element of the matrix F_{N};
factorizing the sparse factor matrix F_{N} of the N-point DFT matrix by a formula of:
$${F}_{N} = {P}_{N} {\prod }_{i = 1}^{t} {A}_{i} ,$$
wherein t=log₂N, and P_{N} is a bit-reversal order permutation matrix,
in a case where the bit-reversal order permutation matrix P_{N}=[eᵣ_{_{N,(1)}}, eᵣ_{_{N,(2)}}, . . . eᵣ_{_{N,(N)}}] as a bit-reversed sequence is r_{N}, wherein eₗ dis a l+1th column of a N×N unit matrix, r_{N,(l)} is a lth element of r_{N}, Aᵢ is expressed as
$${A}_{i} = blk diag ( [ \begin{matrix}1 & {ω}_{N}^{{r}_{N , ( 1 )}} \\ 1 & {ω}_{N}^{{r}_{N , ( 2 )}}\end{matrix} ] , [ \begin{matrix}1 & {ω}_{N}^{{r}_{N , ( 3 )}} \\ 1 & {ω}_{N}^{{r}_{N , ( 4 )}}\end{matrix} ] , … , [ \begin{matrix}1 & {ω}_{N}^{{r}_{N , ( {2}^{( t - i + 1 )} - 1 )}} \\ 1 & {ω}_{N}^{{r}_{N , ( {2}^{( t - i + 1 )} )}}\end{matrix} ] ) ⊗ {I}_{{2}^{i - 1}} ,$$
wherein blkdiag(·) denotes a block diagonal matrix comprising specified matrices on a diagonal of the block diagonal matrix, ⊗ is a Kronecker product operation, and r_{N,(l)} is a lth element of r_{N};
mapping the matrix Aᵢ to a first feasible set [symbol] ={0, ±1, ±2, . . . , ±2^{q}} and obtaining a first quantized-mapping factor matrix Âᵢ;
performing amplitude calibration and phase calibration on the first quantized-mapping factor matrix and obtaining a first mapped-calibrated factor matrix ĤᵢÂᵢ, such that a mapped-calibrated sparse factor matrix is obtained;
obtaining the approximate DFT matrix by applying a real scaling factor β and optimizing the mapped-calibrated sparse factor matrix,
wherein the approximate DFT matrix
$${\hat{F}}_{N} = \hat{β} {{\prod }^{t - 2}}_{i = 1} {\hat{H}}_{i} {\hat{A}}_{i} {A}_{t - 1} {A}_{t} ;$$
wherein
$$\hat{β} = Re ( \frac{Tr ( {F}_{N}^{†} {P}_{N} {G}_{N} )}{Tr ( {G}_{N}^{†} {G}_{N} )} ) .$$

13. A communication system, comprising a transmitter and a receiver;
the transmitter comprising a modulator, a first multiplier, and a post-processing circuit, the modulator being connected to an input end of the transmitter, the first multiplier being connected to an output end of the modulator, and the post-processing circuit being connected to an output end of the first multiplier;
wherein the modulator is configured to modulate and convert the bitstream and obtain a frequency domain signal matrix;
the first multiplier is configured to multiply the frequency domain signal matrix with an inverse approximate Discrete Fourier Transform (DFT) matrix and obtain a time domain signal matrix, the inverse approximate Discrete Fourier Transform (DFT) matrix being an inverse matrix of an approximate Discrete Fourier Transform (DFT);
the post-processing circuit is configured to post-process the time domain signal matrix and obtain a time domain signal, and send the first domain signal to the receiver connected with the transmitter;
the receiver comprises a pre-processing circuit, a second multiplier, and a demodulator; the pre-processing circuit is connected to an input end of the receiver; the second multiplier is connected to an output end of the pre-processing circuit; the demodulator is connected to an output end of the second multiplier;
the pre-processing circuit is configured to pre-process a time domain signal received from a transmitter connected with the receiver and obtain a time domain signal matrix;
the second multiplier is configured to multiply the time domain signal matrix with an approximate DFT matrix and obtain a frequency domain signal matrix;
the demodulator is configured to demodulate and convert the frequency domain signal matrix and obtain a bitstream.

14. The communication system of claim 13, wherein determining the inverse approximate DFT matrix comprises:
determining an approximate DFT matrix;
performing conjugate transpose on the approximate DFT matrix and dividing by N to obtain the inverse approximate DFT matrix.

15. The communication system of claim 14, wherein the determining the approximate DFT matrix comprises:
constructing a sparse factor matrix F_{N} of an N-point DFT matrix, where N is a power of two integer, based on a symmetric structure of the DFT matrix, wherein
$${F}_{N , ( k , i )} = {ω}_{N}^{( k - 1 ) ( i - 1 )} ,$$
k=1, 2, . . . , N, i=1, 2, . . . , N,
wherein ω_{N}=e^{-2π/N} is a Nth unit root, j=\sqrt{−1} is an imaginary unit,
$${ω}_{N}^{( k - 1 ) ( i - 1 )}$$
represents a (k−1)(i−1)th power of ω_{N}, and F_{N,(k,i)} represents a (k,i)th element of the matrix F_{N};
factorizing the sparse factor matrix F_{N} of the N-point DFT matrix by a formula of:
$${F}_{N} = {P}_{N} {\prod }_{i = 1}^{t} {A}_{i} ,$$
wherein t=log₂N, and P_{N} is a bit-reversal order permutation matrix,
in a case where the bit-reversal order permutation matrix P_{N}=[eᵣ_{_{N,(1)}}, eᵣ_{_{N,(2)}}, . . . eᵣ_{_{N,(N)}}] as a bit-reversed sequence is r_{N}, wherein eₗ is a l+1th column of a N×N unit matrix, r_{N,(l)} is a lth element of r_{N}, Aᵢ is expressed as
$${A}_{i} = blkdiag ( [ \begin{matrix}1 & {ω}_{N}^{{r}_{N , ( 1 )}} \\ 1 & {ω}_{N}^{{r}_{N , ( 2 )}}\end{matrix} ] , [ \begin{matrix}1 & {ω}_{N}^{{r}_{N , ( 3 )}} \\ 1 & {ω}_{N}^{{r}_{N , ( 4 )}}\end{matrix} ] , … , [ \begin{matrix}1 & {ω}_{N}^{{r}_{N , ( {2}^{( t - i + 1 )} - 1 )}} \\ 1 & {ω}_{N}^{{r}_{N , ( {2}^{( t - i + 1 )} )}}\end{matrix} ] ) ⊗ {I}_{{2}^{i - 1}} ,$$
wherein blkdiag(·) denotes a block diagonal matrix comprising specified matrices on a diagonal of the block diagonal matrix, ⊗ is a Kronecker product operation, and r_{N,(l)} is a lth element of r_{N};
mapping the matrix Aᵢ to a first feasible set [symbol] ={0, ±1, ±2, . . . , ±2^{q}} and obtaining a first quantized-mapping factor matrix Âᵢ;
performing amplitude calibration and phase calibration on the first quantized-mapping factor matrix and obtaining a first mapped-calibrated factor matrix ĤᵢÂᵢ, such that a mapped-calibrated sparse factor matrix is obtained;
obtaining the approximate DFT matrix by applying a real scaling factor β and optimizing the mapped-calibrated sparse factor matrix,
wherein the approximate DFT matrix
$${\hat{F}}_{N} = \hat{β} {\prod }_{i = 1}^{t - 2} {\hat{H}}_{i} {\hat{A}}_{i} {A}_{t - 1} {A}_{t} ;$$
wherein
$$\hat{β} = Re ( \frac{T r ( {F}_{N}^{†} {P}_{N} {G}_{N} )}{T r ( {G}_{N}^{†} {G}_{N} )} ) .$$

16. The communication system of claim 14, wherein the determining the approximate DFT matrix comprises:
constructing a sparse factor matrix F_{N} of an N-point DFT matrix, where N is a power of two integer, based on a symmetric structure of the DFT matrix, wherein
$${F}_{N , ( k , i )} = {ω}_{N}^{( k - 1 ) ( i - 1 )} ,$$
k=1, 2, . . . , N, i=1, 2, . . . , N,
wherein ω_{N}=e^{-j2π/N} is a Nth unit root, j=\sqrt{−1} is an imaginary unit,
$${ω}_{N}^{( k - 1 ) ( i - 1 )}$$
represents a (k−1)(i−1)th power of ω_{N}, and F_{N,(k,i)} represents a (k,i)th element of the matrix F_{N};
factorizing the sparse factor matrix F_{N} of the N-point DFT matrix by a formula of:
$${F}_{N} = {P}_{N} {\prod }_{i = 1}^{t} {A}_{i} ,$$
wherein t=log₂N, and P_{N} dis a bit-reversal order permutation matrix,
in a case where the bit-reversal order permutation matrix P_{N}=[eᵣ_{_{N,(1)}}, eᵣ_{_{N,(2)}}, . . . eᵣ_{_{N,(N)}}] as a bit-reversed sequence is r_{N}, wherein eₗ is a l+1th column of a N×N unit matrix, r_{N,(l)} is a lth element of r_{N}, Aᵢ is expressed as
$${A}_{i} = blkdiag ( [ \begin{matrix}1 & {ω}_{N}^{{r}_{N , ( 1 )}} \\ 1 & {ω}_{N}^{{r}_{N , ( 2 )}}\end{matrix} ] , [ \begin{matrix}1 & {ω}_{N}^{{r}_{N , ( 3 )}} \\ 1 & {ω}_{N}^{{r}_{N , ( 4 )}}\end{matrix} ] , … , [ \begin{matrix}1 & {ω}_{N}^{{r}_{N , ( {2}^{( t - i + 1 )} - 1 )}} \\ 1 & {ω}_{N}^{{r}_{N , ( {2}^{( t - i + 1 )} )}}\end{matrix} ] ) ⊗ {I}_{{2}^{i - 1}} ,$$
wherein blkdiag(·) denotes a block diagonal matrix comprising specified matrices on a diagonal of the block diagonal matrix, ⊗ is a Kronecker product operation, and r_{N,(l)} is a lth element of r_{N};
mapping the matrix Aᵢ to a second feasible set
$$𝒩 = \{ 0 , \pm \frac{1}{2} , \pm 1 \}$$
and obtaining a second quantized-mapping factor matrix Âᵢ;
performing amplitude calibration and phase calibration on the second quantized-mapping factor matrix and obtaining a second mapped-calibrated factor matrix ĤᵢÂᵢ, such that a mapped-calibrated sparse factor matrix is obtained;
obtaining the approximate DFT matrix by applying a real scaling factor β to optimize the mapped-calibrated sparse factor matrix,
wherein the approximate DFT matrix
$${\hat{F}}_{N} = \hat{β} {\prod }_{i = 1}^{t - 2} {\hat{H}}_{i} {\hat{A}}_{i} {A}_{t - 1} {A}_{t} ;$$
$$wherein$$
$$\hat{β} = Re ( \frac{T r ( {F}_{N}^{†} {P}_{N} {G}_{N} )}{T r ( {G}_{N}^{†} {G}_{N} )} ) .$$

17. The communication system of claim 15, wherein the performing amplitude calibration and phase calibration on the first quantized-mapping factor matrix and obtaining a first mapped-calibrated factor matrix ĤᵢÂᵢ, such that a mapped-calibrated sparse factor matrix is obtained comprises:
constructing a least squares calibration matrix
$${\overline{H}}_{i} = arg {min}_{{H}_{i}} {‖ {H}_{i} {\hat{A}}_{i} - {A}_{i} ‖}_{F}^{2} ,$$
wherein ∥·∥_{F} is the Frobenius norm, and Hᵢ is a calibration matrix;
mapping the least squares calibration matrix to the first feasible set and obtaining a first calibrated factor matrix Ĥᵢ;
calibrating the first quantized-mapping factor matrix Âᵢ based on first calibrated factor matrix Ĥᵢ and obtaining the first mapped-calibrated factor matrix ĤᵢÂᵢ.

18. The communication system of claim 16, wherein performing amplitude calibration and phase calibration on the second quantized-mapping factor matrix and obtaining a second mapped-calibrated factor matrix ĤᵢÂᵢ, such that a mapped-calibrated sparse factor matrix is obtained comprises:
constructing a least squares calibration matrix
$${\overline{H}}_{i} = arg {min}_{{H}_{i}} {‖ {H}_{i} {\hat{A}}_{i} - {A}_{i} ‖}_{F}^{2} ,$$
wherein ∥·∥_{F} is the Frobenius norm, and Hᵢ is a calibration matrix;
calibrating the second quantized-mapping factor matrix Âᵢ based on second calibrated factor matrix Ĥᵢ and obtaining the second mapped-calibrated factor matrix ĤᵢÂᵢ.

19. The communication system of claim 15, wherein the mapping the matrix Aᵢ to a first feasible set [symbol] ={0, ±1, ±2, . . . , ±2^{q}} and obtaining a first quantized-mapping factor matrix Âᵢ, comprises:
mapping, in condition of all elements in a matrix Aₜ₋₁ and a matrix Aₜ satisfying constraints of the first feasible set, rest of matrices Aᵢ to the first feasible set.

20. The communication system of claim 16, wherein the mapping the matrix Aᵢ to a second feasible set
$$𝒩 = \{ 0 , \pm \frac{1}{2} , \pm 1 \}$$
and obtaining a second quantized-mapping factor matrix Âᵢ, comprises:
mapping, in condition of all elements in a matrix Aₜ₋₁ and a matrix Aₜ satisfying constraints of the second feasible set, rest of matrices Aᵢ to the second feasible set.
